(19) United States
(12) Patent Application Publication
(10) Pub. No.: US 2024/0340851 A1
(43) Pub. Date: Oct. 10, 2024

(54) MONITORING PAGING OF REMOTE UE BY RELAY UE

(71) Applicant: Samsung Electronics Co., Ltd., Suwon-si (KR)

(72) Inventor: Anil Agiwal, Allen, TX (US)

(21) Appl. No.: 18/611,599

(22) Filed: Mar. 20, 2024

Related U.S. Application Data
(60) Provisional application No. 63/457,259, filed on Apr. 5, 2023.

(51) Int. Cl. H04W 68/02; H04W 76/19; H04W 76/20; H04W 76/40

(52) U.S. Cl. CPC H04W 68/02; H04W 76/19; H04W 76/20; H04W 76/40

(57) ABSTRACT

A relay UE includes a transceiver configured to receive, from a remote UE, an identity for the remote UE, and receive, from a BS, a paging message including a first paging record list of a first type of paging record and a second paging record list of a second type of paging record. The relay UE further includes a processor operably coupled to the transceiver, the processor configured to determine that the remote UE is associated with the paging message, identify a first paging record of the first type from the first paging record list comprising the identity of the remote UE, identify a second paging record of the second type from the second paging record list comprising a paging cause, and generate a UuMessageTransferSidelink message including the first paging record and the second paging record. The transceiver is further configured to transmit, to the remote UE, the UuMessageTransferSidelink message.

### CROSS-REFERENCE TO RELATED APPLICATION AND CLAIM OF PRIORITY

This application claims priority under 35 U.S.C. § 119(e) to U.S. Provisional Patent Application No. 63/457,259 filed on Apr. 5, 2023. The above-identified provisional patent application is hereby incorporated by reference in its entirety.

### TECHNICAL FIELD

This disclosure relates generally to wireless networks. More specifically, this disclosure relates to apparatuses and methods for monitoring paging of a remote UE by a relay UE.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for monitoring paging of a remote UE by a relay UE.

In one embodiment, a relay user equipment (UE) is provided. The relay UE includes a transceiver configured to receive, from a remote UE, an identity for the remote UE, and receive, from a base station (BS), a paging message including a first paging record list of a first type of paging record and a second paging record list of a second type of paging record. The relay UE further includes a processor operably coupled to the transceiver. The processor is configured to determine that the remote UE is associated with the paging message, identify a first paging record of the first type from the first paging record list comprising the identity of the remote UE, identify a second paging record of the second type from the second paging record list comprising a paging cause, and generate a UuMessageTransferSidelink message including the first paging record and the second paging record. The transceiver is further configured to transmit, to the remote UE, the UuMessageTransferSidelink message.

In another embodiment, a BS is provided. The BS includes a processor and a transceiver operably coupled to the processor. The transceiver is configured to receive, from a remote UE, a first list of temporary mobile group identities (TMGIs) for monitoring paging for multicast and broadcast services (MBS), and transmit, to the UE, a paging message including a first paging record list of a first type of paging record, a second paging record list of a second type of paging record, and a second list of TMGIs including at least one TMGI from the first list of TMGIs.

In yet another embodiment, a method of operating a relay UE is provided. The method includes receiving, from a remote UE, an identity for the remote UE, receiving, from a BS, a paging message including a first paging record list of a first type of paging record and a second paging record list of a second type of paging record, and determining that the remote UE is associated with the paging message. The method further includes identifying a first paging record of the first type from the first paging record list comprising the identity of the remote UE, and identifying a second paging record of the second type from the second paging record list comprising a paging cause. The method further includes generating a UuMessageTransferSidelink message including the first paging record and the second paging record, and transmitting, to the remote UE, the UuMessageTransferSidelink message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of sidelink communication according to embodiments of the present disclosure;

FIGS. 5A-5B illustrate a method for monitoring paging of a remote UE by a relay UE according to embodiments of the present disclosure;

FIG. 6 illustrates a method for a remote UE responding to a UuMessageTransferSidelink message while in an RRC idle state according to embodiments of the present disclosure;

FIGS. 7A-7C illustrate a method for a remote UE responding to a UuMessageTransferSidelink message while in an RRC inactive state according to embodiments of the present disclosure; and

FIG. 8 illustrates a method for monitoring paging of a remote UE by a relay UE according to embodiments of the present disclosure.

### DETAILED DESCRIPTION

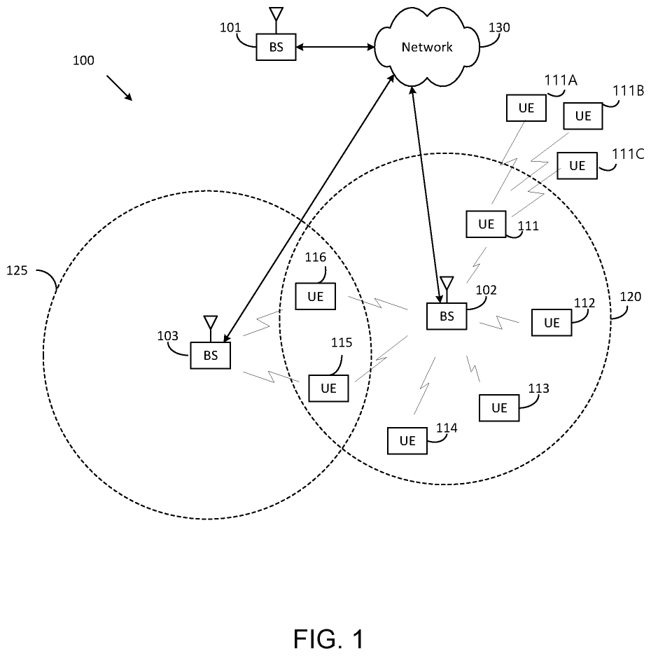

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for monitoring paging of a remote UE by a relay UE. In certain embodiments, one or more of the gNBs 101-103 includes circuitry, programing, or a combination thereof, to support monitoring paging of a remote UE by a relay UE in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

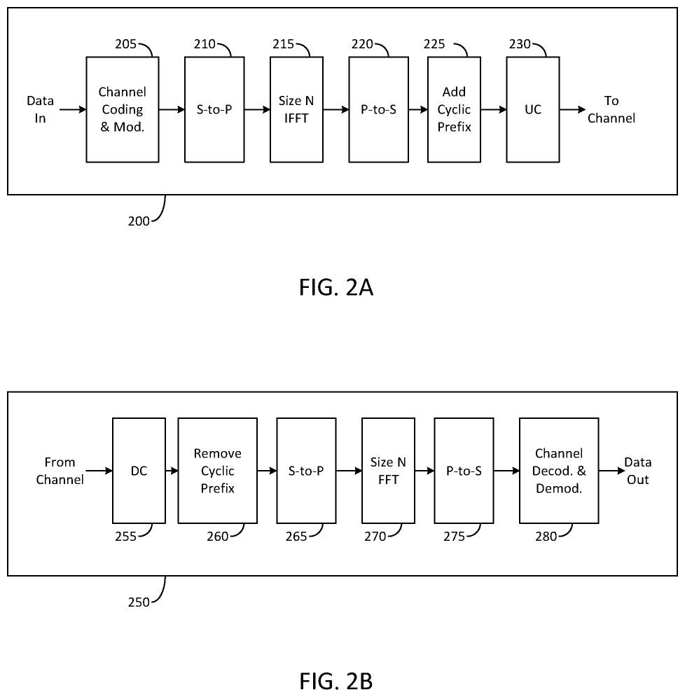

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

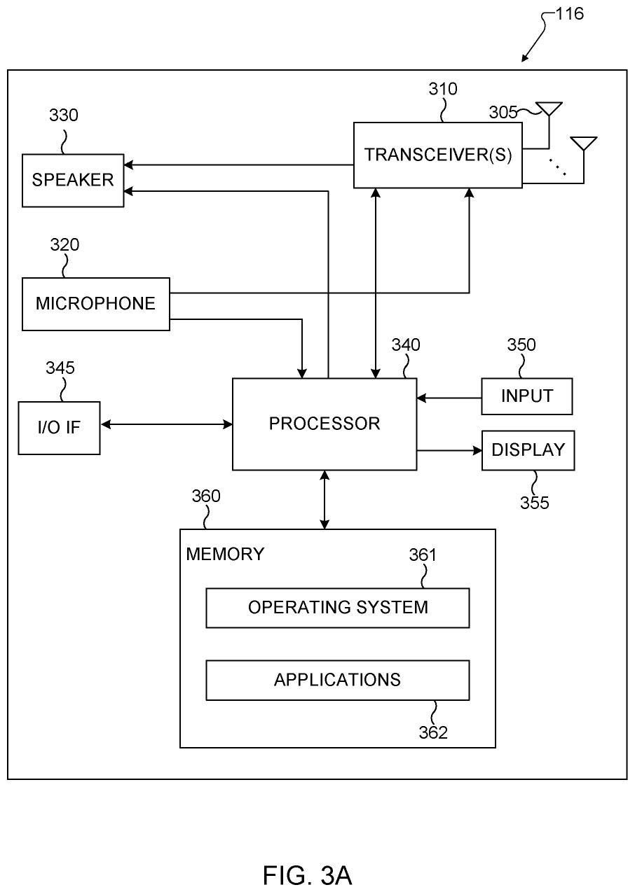

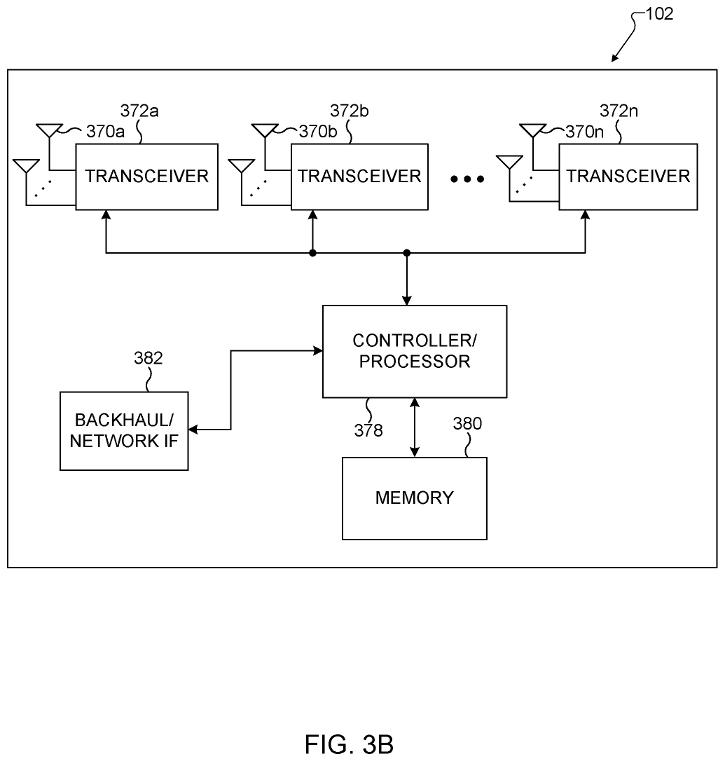

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for monitoring paging of a remote UE by a relay UE as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support monitoring paging of a remote UE by a relay UE as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The fifth-generation wireless communication system supports not only lower frequency bands but also higher frequency (mmWave) bands, e.g., 10 GHz to 100 GHz bands, so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, and analog beam forming, large scale antenna techniques are being considered in the design of fifth generation wireless communication systems. In addition, the fifth-generation wireless communication system is expected to address different use cases having quite different requirements in terms of data rate, latency, reliability, mobility etc. However, it is expected that the design of the air-interface of the fifth-generation wireless communication system would be flexible enough to serve UEs having quite different capabilities depending on the use case and market segment the UE caters to service the end customer. A few example use cases the fifth-generation wireless communication system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility so on and so forth address the market segment representing conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing Industrial automation applications, and vehicle-to-vehicle/vehicle-to-infrastructure communication which is foreseen as one of the enablers for autonomous cars.

In the fifth-generation wireless communication system operating in higher frequency (mmWave) bands, UEs and gNBs communicate with each other using Beamforming. Beamforming techniques are used to mitigate the propagation path losses and to increase the propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can make a plurality of transmit beam patterns of different directions. Each of these transmit beam patterns can be also referred as transmit (TX) beam. Wireless communication systems operating at high frequency use a plurality of narrow TX beams to transmit signals in the cell as each narrow TX beam provides coverage to a part of cell. The narrower the TX beam, the higher the antenna gain and hence the larger the propagation distance of signal transmitted using beamforming. A receiver can also make plurality of receive (RX) beam patterns of different directions. Each of these receive patterns can be also referred to as a receive (RX) beam.

The fifth generation wireless communication system supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in the RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in the RRC_CONNECTED state not configured with CA/DC there is only one serving cell comprising of the primary cell. For a UE in the RRC_CONNECTED state configured with CA/DC the term ‘serving cells’ is used to denote the set of cells comprising of the Special Cell(s) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR, PCell (primary cell) refers to a serving cell in a MCG, operating on the primary frequency, in which the UE either performs the initial connection establishment procedure or initiates the connection re-establishment procedure. In NR for a UE configured with CA, an Scell is a cell providing additional radio resources on top of a Special Cell. Primary SCG Cell (PSCell) refers to a serving cell in a SCG in which the UE performs random access when performing a Reconfiguration with Sync procedure. For Dual Connectivity operation the term SpCell (i.e., Special Cell) refers to the PCell of the MCG or the PSCell of the SCG, otherwise the term Special Cell refers to the PCell.

In the fifth generation wireless communication system, a node B (gNB) or base station in a cell broadcast Synchronization Signal and PBCH block (SSB) comprises primary and secondary synchronization signals (PSS, SSS) and system information. System information includes common parameters needed to communicate in a cell. In the fifth generation wireless communication system (also referred as next generation radio or NR), System Information (SI) is divided into the MIB and a number of SIBs where the MIB is transmitted on the BCH with a periodicity of 80 ms and repetitions made within 80 ms and the SI includes parameters that are needed to acquire a SIB1 from the cell. The SIB1 is transmitted on the DL-SCH with a periodicity of 160 ms and variable transmission repetition. The default transmission repetition periodicity of a SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which includes one or several cells and is identified by systemInformationAreaID; The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in the RRC_CONNECTED state, the network can provide system information through dedicated signaling using the RRCReconfiguration message. For example, if the UE has an active BWP with no common search space configured to monitor system information, paging, or upon request from the UE. In the RRC_CONNECTED state, the UE needs to acquire the required SIB(s) only from the PCell. For PSCell and SCells, the network provides the required SI by dedicated signaling, i.e., within an RRCReconfiguration message. Nevertheless, the UE acquires a MIB of the PSCell to get SFN timing of the SCG (which may be different from MCG). Upon change of relevant SI for SCell, the network releases and adds the concerned SCell. For a PSCell, the required SI can only be changed with Reconfiguration with Sync.

In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in the RRC CONNECTED state. Several types of random-access procedures are supported such as contention based random access, contention free random access and each of these can be one of 2 step or 4 step random access.

In the fifth generation wireless communication system, the Physical Downlink Control Channel (PDCCH) is used to schedule DL transmissions on PDSCH and UL transmissions on PUSCH, where the Downlink Control Information (DCI) on PDCCH includes: Downlink assignments containing at least modulation and coding format, resource allocation, and hybrid-ARQ information related to DL-SCH; Uplink scheduling grants containing at least modulation and coding format, resource allocation, and hybrid-ARQ information related to UL-SCH. In addition to scheduling, PDCCH can be used to for activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; Transmission of TPC commands for PUCCH and PUSCH; Transmission of one or more TPC commands for SRS transmissions by one or more UEs; Switching a UE's active bandwidth part; Initiating a random access procedure. A UE monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCEs. Different code rates for the control channels are realized by aggregating a different number of CCEs. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the fifth-generation wireless communication system, a list of search space configurations is signaled by the GNB for each configured BWP of a serving cell wherein each search configuration is uniquely identified by a search space identifier. The search space identifier is unique amongst the BWPs of a serving cell. An identifier of search space configuration to be used for a specific purpose such as paging reception, SI reception, and random access response reception is explicitly signaled by the gNB for each configured BWP. In NR, search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having a PDCCH monitoring occasion is given by Monitoring-symbols-PDCCH-within-slot. The length (in symbols) of a PDCCH monitoring occasion is given in the corset associated with the search space. The search space configuration includes the identifier of the coreset configuration associated with it. A list of coreset configurations are signaled by the GNB for each configured BWP of the serving cell wherein each coreset configuration is uniquely identified by an coreset identifier. The coreset identifier is unique amongst the BWPs of a serving cell. Note that each radio frame is of 10 ms duration. A radio frame is identified by a radio frame number or system frame number. Each radio frame comprises of several slots wherein the number of slots in a radio frame and duration of slots depends on sub carrier spacing. The number of slots in a radio frame and duration of slots in a radio frame for each supported SCS is pre-defined in NR. Each coreset configuration is associated with a list of TCI (Transmission configuration indicator) states. One DL RS ID (SSB or CSI RS) is configured per TCI state. The list of TCI states corresponding to a coreset configuration is signaled by the gNB via RRC signaling. One of the TCI state in a TCI state list is activated and indicated to a UE by the gNB. TCI state indicates the DL TX beam (DL TX beam is QCLed with SSB/CSI RS of TCI state) used by the GNB for transmission of PDCCH in the PDCCH monitoring occasions of a search space.

In the fifth-generation wireless communication system, bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring a RRC connected UE with BWP(s) and telling the UE which of the configured BWPs is currently the active one. When BA is configured, the UE only has to monitor PDCCH on the one active BWP. That is, it does not have to monitor PDCCH on the entire DL frequency of the serving cell. In the RRC connected state, the UE is configured with one or more DL and UL BWPs, for each configured Serving Cell (i.e., PCell or SCell). For an activated Serving Cell, there is one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random-Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of the BWP inactivity timer the UE switches the active DL BWP to the default DL BWP or initial DL BWP (if default DL BWP is not configured).

In the fifth generation wireless communication system, a UE can be in one of the following RRC states: RRC IDLE, RRC INACTIVE and RRC CONNECTED. The RRC states can further be characterized as follows:
In the RRC_IDLE state, a UE specific DRX may be configured by upper layers (i.e., NAS). The UE monitors Short Messages transmitted with P-RNTI over DCI; Monitors a Paging channel for CN paging using 5G-S-TMSI; —Performs neighbouring cell measurements and cell (re-)selection; Acquires system information and can send SI request (if configured).
In the RRC_INACTIVE state, a UE specific DRX may be configured by upper layers or by RRC layer; In this state, UE stores the UE Inactive AS context. A RAN-based notification area is configured by RRC layer. The UE monitors Short Messages transmitted with P-RNTI over DCI; Monitors a Paging channel for CN paging using 5G-S-TMSI and RAN paging using full I-RNTI; Performs neighbouring cell measurements and cell (re-)selection; Performs RAN-based notification area updates periodically and when moving outside the configured RAN-based notification area; Acquires system information and can send SI request (if configured).
In the RRC_CONNECTED state, the UE stores the AS context. Unicast data is transmitted/received to/from UE. At lower layers, the UE may be configured with a UE specific DRX. The UE monitors Short Messages transmitted with P-RNTI over DCI, if configured; Monitors control channels associated with the shared data channel to determine if data is scheduled for it; Provides channel quality and feedback information; Performs neighbouring cell measurements and measurement reporting; Acquires system information.

The 5G or Next Generation Radio Access Network (NG-RAN) based on NR includes NG-RAN nodes where an NG-RAN node is a gNB, providing NR user plane and control plane protocol terminations towards the UE. The gNBs are also connected by means of the NG interfaces to the 5GC, more specifically to the AMF (Access and Mobility Management Function) by means of the NG-C interface and to the UPF (User Plane Function) by means of the NG-U interface. In the fifth generation wireless communication system, the UE may use Discontinuous Reception (DRX) in the RRC_IDLE and RRC_INACTIVE state in order to reduce power consumption. In the RRC_IDLE/RRC_INACTIVE state the UE wake ups at regular intervals (i.e., every DRX cycle) for short periods to receive paging, to receive SI update notifications and to receive emergency notifications. A paging message is transmitted using a physical downlink shared channel (PDSCH). The physical downlink common control channel (PDCCH) is addressed to P-RNTI if there is a paging message in PDSCH. P-RNTI is common for all UEs. A UE identity (i.e., S-TMSI for RRC_IDLE UE or I-RNTI for RRC_INACTIVE UE) is included in the paging message to indicate paging for a specific UE. The Paging message may include multiple UE identities to page multiple UEs. The Paging message is broadcasted (i.e., PDCCH is masked with P-RNTI) over a data channel (i.e., PDSCH). SI update and emergency notifications are included in DCI and PDCCH carrying this DCI is addressed to P-RNTI. In the RRC idle/inactive mode the UE monitors one paging occasion (PO) every DRX cycle. In the RRC idle/inactive mode the UE monitors PO in an initial DL BWP. In the RRC connected state the UE monitors one or more POs to receive SI update notifications and to receive emergency notifications. In the RRC connected state, the UE can monitor any PO in the paging DRX cycle and monitors at least one PO in the SI modification period. In the RRC idle/inactive mode the UE monitors PO every DRX cycle in its active DL BWP. A PO is a set of ‘S’ PDCCH monitoring occasions for paging, where ‘S’ is the number of transmitted SSBs (i.e., the Synchronization Signal and PBCH block (SSB) includes primary and secondary synchronization signals (PSS, SSS) and PBCH) in cell. The UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE_ID mod N).
Index (i_s), indicating the index of the PO is determined by i_s=floor(UE ID/N) mod Ns.
T is DRX cycle of the UE.
   In the RRC_INACTIVE state, T is determined by the shortest of the UE specific DRX value configured by RRC, UE specific DRX value configured by NAS, and a default DRX value broadcast in system information.
   In the RRC_IDLE state, T is determined by the shortest of UE specific DRX value configured by NAS, and a default DRX value broadcast in system information. If UE specific DRX is not configured by upper layers (i.e., NAS), the default value is applied.
N: number of total paging frames in T
Ns: number of paging occasions for a PF
PF_offset: offset used for PF determination
UE_ID: 5G-S-TMSI mod 1024
Parameters Ns, nAndPagingFrameOffset, and the length of default DRX Cycle are signaled in SIB1. The values of N and PF_offset are derived from the parameter nAndPagingFrameOffset. If the UE has no 5G-S-TMSI, for instance when the UE has not yet registered onto the network, the UE shall use as default identity UE_ID=0 in the PF and i_s formulas above.
The PDCCH monitoring occasions for paging are determined based on paging search space configuration (paging-SearchSpace) signaled by gNB.
When SearchSpaceId=0 is configured for pagingSearchSpace, the PDCCH monitoring occasions for paging are same as for RMSI. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceId other than 0 is configured for pagingSearchSpace, the UE monitors the (i_s+1)^{th} PO. The PDCCH monitoring occasions for paging are determined based on paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal parameterfirstPDCCH-MonitoringOccasionOfPO for each PO corresponding to a PF. WhenfirstPDCCH-MonitoringOccasionOfPO is signalled, the (i_s+1)^{th} PO is a set of ‘S’ consecutive PDCCH monitoring occasions for paging starting from the PDCCH monitoring occasion number indicated by firstPDCCH-MonitoringOccasionOfPO (i.e., the (i_s+1)^{th} value of thefirstPDCCH-MonitoringOccasionOfPO parameter). Otherwise, the (i_s+1)^{th} PO is a set of ‘S’ consecutive PDCCH monitoring occasions for paging starting from the (i_s*S)^{th} PDCCH monitoring occasion for paging. ‘S’ is the number of actual transmitted SSBs determined according to parameter ssb-PositionsInBurst signalled in SystemInformationBlock1 received from gNB. The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration.

The 4G and 5G wireless communication system supports vehicular communication services. Vehicular communication services, represented by V2X services, can include the following four different types: V2V, V2I, V2N and V2P. In the fifth generation wireless communication system, V2X communication is being enhanced to support enhanced V2X use cases, which are broadly arranged into four use case groups:
1) Vehicles Platooning enables the vehicles to dynamically form a platoon travelling together. All the vehicles in the platoon obtain information from the leading vehicle to manage this platoon. This information allows the vehicles to drive closer than normal in a coordinated manner, going to the same direction and travelling together.
2) Extended Sensors enables the exchange of raw or processed data gathered through local sensors or live video images among vehicles, road site units, devices of pedestrian and V2X application servers. The vehicles can increase the perception of their environment beyond of what their own sensors can detect and have a broader and holistic view of the local situation. High data rate is one of the key characteristics.
3) Advanced Driving enables semi-automated or full-automated driving. Each vehicle and/or RSU shares its own perception data obtained from its local sensors with vehicles in proximity and that allows vehicles to synchronize and coordinate their trajectories or manoeuvres. Each vehicle shares its driving intention with vehicles in proximity too.
4) Remote Driving enables a remote driver or a V2X application to operate a remote vehicle for those passengers who cannot drive by themselves, or remote vehicles located in dangerous environments. For a case where variation is limited and routes are predictable, such as public transportation, driving based on cloud computing can be used. High reliability and low latency are the main requirements.

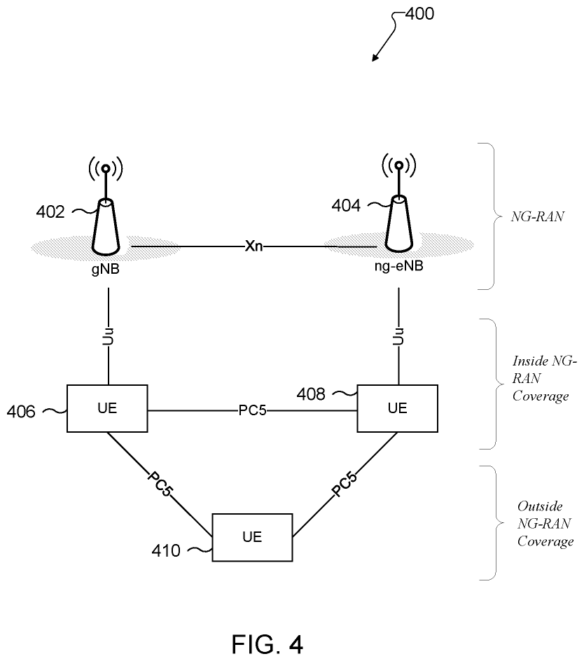

V2X services can be provided by PC5 interface and/or Uu interface. Support of V2X services via PC5 interface is provided by NR sidelink communication or V2X sidelink communication, which is a mode of communication whereby UEs can communicate with each other directly over the PC5 interface using NR technology or EUTRA technology respectively without traversing any network node. This communication mode is supported when the UE is served by RAN and when the UE is outside of RAN coverage. Only the UEs authorized to be used for V2X services can perform NR or V2X sidelink communication. The NG-RAN architecture supports the PC5 interface as illustrated in FIG. 1. Sidelink transmission and reception over the PC5 interface are supported when the UE is inside NG-RAN coverage, irrespective of which RRC state the UE is in, and when the UE is outside NG-RAN coverage. Support of V2X services via the PC5 interface can be provided by NR Sidelink Communication and/or V2X Sidelink Communication. NR Sidelink Communication may be used to support other services than V2X services. An example of sidelink communication is shown in FIG. 4.

FIG. 4 illustrates an example 400 of sidelink communication according to embodiments of the present disclosure. The embodiment of a sidelink communication in FIG. 4 is for illustration only. Other embodiments of sidelink communication could be used without departing from the scope of this disclosure.

In the example of FIG. 4, a gNB 402 is in communication with an ng-eNB 404 via an Xn interface. gNB 402 and ng-eNB 404 provide NG-RAN coverage. UE 406 and UE 408 are inside the NG-RAN coverage provided by gNB 402 and ng-eNB 404. UE 406 is in communication with 402 via a Uu interface, and UE 408 is in communication with ng-eNB 404 via a Uu interface. UE 406 and UE 408 are also in sidelink communication with each other via a PC5 interface. UE 410, which is outside the NG-RAN coverage provided by NB 402 and ng-eNB 404 is in sidelink communication with UE 406 and UE 408 via separate PC5 interfaces.

Although FIG. 4 illustrates one example 400 of sidelink communication, various changes may be made to FIG. 4. For example, the number of UEs may vary, the number of gNBs may vary, etc. according to particular needs.

NR or V2X Sidelink Communication can support three types of transmission modes: unicast, groupcast, and broadcast. Unicast transmission is characterized by: support of at least one PC5-RRC connection between peer UEs; Transmission and reception of control information and user traffic between peer UEs in sidelink; Support of sidelink HARQ feedback; Support of RLC AM; and Support of sidelink RLM for both peer UEs to detect RLF. Groupcast transmission is characterized by: Transmission and reception of user traffic among UEs belonging to a group in sidelink; Support of sidelink HARQ feedback. Broadcast transmission is characterized by: Transmission and reception of user traffic among UEs in sidelink.

The AS protocol stack for the control plane in the PC5 interface includes RRC, PDCP, RLC and MAC sublayer, and the physical layer. The AS protocol stack for the user plane in the PC5 interface includes SDAP, PDCP, RLC and MAC sublayer, and the physical layer. Sidelink Radio bearers (SLRB) are categorized into two groups: sidelink data radio bearers (SL DRB) for user plane data and sidelink signaling radio bearers (SL SRB) for control plane data. Separate SL SRBs using different SCCHs are configured for PC5-RRC and PC5-S signaling respectively.

The MAC sublayer provides the following services and functions over the PC5 interface: Radio resource selection; Packet filtering; Priority handling between uplink and sidelink transmissions for a given UE; and Sidelink CSI reporting. With LCP restrictions in MAC, only sidelink logical channels belonging to the same destination can be multiplexed into a MAC PDU for every unicast, groupcast and broadcast transmission which is associated to the destination. NG-RAN can also control whether a sidelink logical channel can utilize the resources allocated to a configured sidelink grant Type 1. For packet filtering, a SL-SCH MAC header including portions of both Source Layer-2 ID and a Destination Layer-2 ID is added to each MAC PDU. LCID included within a MAC subheader uniquely identifies a logical channel within the scope of the Source Layer-2 ID and Destination Layer-2 ID combination. The following logical channels are used in sidelink:
Sidelink Control Channel (SCCH): a sidelink channel for transmitting control information from one UE to other UE(s);
Sidelink Traffic Channel (STCH): a sidelink channel for transmitting user information from one UE to other UE(s);
Sidelink Broadcast Control Channel (SBCCH): a sidelink channel for broadcasting sidelink system information from one UE to other UE(s).

The following connections between logical channels and transport channels exist:
SCCH can be mapped to SL-SCH;
STCH can be mapped to SL-SCH;
SBCCH can be mapped to SL-BCH.

The RRC sublayer provides the following services and functions over the PC5 interface:
Transfer of a PC5-RRC message between peer UEs;
Maintenance and release of a PC5-RRC connection between two UEs;
Detection of sidelink radio link failure for a PC5-RRC connection.

A PC5-RRC connection is a logical connection between two UEs for a pair of Source and Destination Layer-2 IDs which is considered to be established after a corresponding PC5 unicast link is established. There is one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages are used for a UE to transfer UE capability and sidelink configuration including SLRB configuration to the peer UE. Both peer UEs can exchange their own UE capability and sidelink configuration using separate bi-directional procedures in both sidelink directions. If the UE is not interested in sidelink transmission, if sidelink RLF on the PC5-RRC connection is declared, or if the Layer-2 link release procedure is completed, the UE releases the PC5-RRC connection.

The sidelink or PC5 interface supports UE-to-UE direct communication using sidelink resource allocation modes, and physical-layer signals/channels. Two sidelink resource allocation modes are supported: mode 1 and mode 2. In mode 1, the sidelink resource allocation is provided by the network. In mode 2, the UE decides the SL transmission resources in the resource pool(s).

The Physical Sidelink Control Channel (PSCCH) indicates resource and other transmission parameters used by a UE for PSSCH. PSCCH transmission is associated with a DM-RS. Sidelink control information (1^{st} stage SCI) is transmitted on PSCCH.

The Physical Sidelink Shared Channel (PSSCH) transmits the transport blocks (TBs) of data themselves, and control information for HARQ procedures and CSI feedback triggers, etc. Control information is referred as 2^{nd} stage SCI. At least 6 OFDM symbols within a slot are used for PSSCH transmission. PSSCH transmission is associated with a DM-RS and may be associated with a PT-RS.

The Physical Sidelink Feedback Channel (PSFCH) carries HARQ feedback over the sidelink from a UE which is an intended recipient of a PSSCH transmission to the UE which performed the transmission. The PSFCH sequence is transmitted in one PRB repeated over two OFDM symbols near the end of the sidelink resource in a slot.

The Sidelink synchronization signal includes sidelink primary and sidelink secondary synchronization signals (S-PSS, S-SSS), each occupying 2 symbols and 127 subcarriers. The Physical Sidelink Broadcast Channel (PSBCH) occupies 9 and 5 symbols for normal and extended cyclic prefix cases respectively, including the associated DM-RS.

Sidelink HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

For transmitting data over a PC5 interface, a transmitter UE first transmits 1^{st} Stage SCI over a PSCCH resource. 1^{st} stage SCI includes information about the transport block such as: Priority, Frequency resource assignment, Time resource assignment, resource reservation period, DMRS pattern, 2^{nd} stage SCI format, MCS, number of DMRS port, etc. The transmitter UE then transmits 2^{nd} stage SCI over PSSCH. The second stage SCI includes information such as, HARQ process number, NDI, RV, Source ID, Destination ID, HARQ feedback enabled/disabled indicator, cast type, CSI request, Zone ID, range, etc. The Transmitter UE then transmits TB carrying SL MAC PDU over PSSCH.

Recently UE-to-Network Relaying architecture is being studied where a UE to Network (U2N) Relay UE relays the traffic between a Remote UE and the network. The UE-to-Network Relay UE enables coverage extension and power saving for the Remote UE. The communication between the UE-to-Network Relay and a gNB is based on 5G communication between the UE and the gNB. The communication between the Remote UE and the UE-to-Network Relay UE is based on sidelink communication. The UE-to-Network Relay UE can monitor paging for the Remote UE.

A U2N Remote UE in the RRC IDLE or RRC INACTIVE state can request the U2N Relay UE to monitor paging for itself.
A U2N Relay UE in RRC IDLE or RRC INACTIVE state monitors paging occasions of its connected U2N Remote UE(s). The U2N Relay UE receives a paging message, check the 5G-S-TSMI/I-RNTI of U2N Remote UE(s) and sends a PagingRecord IE to the U2N Remote UE over sidelink using UuMessageTransferSidelink message.
A U2N Relay UE in the RRC CONNECTED state either a) monitors paging occasions of its connected U2N Remote UE(s) and receives paging messages or b) receives paging messages in dedicated RRC messages. The U2N Relay UE checks the 5G-S-TSMI/I-RNTI of the U2N Remote UE(s) in received paging messages and sends a PagingRecord IE to the U2N Remote UE over sidelink.

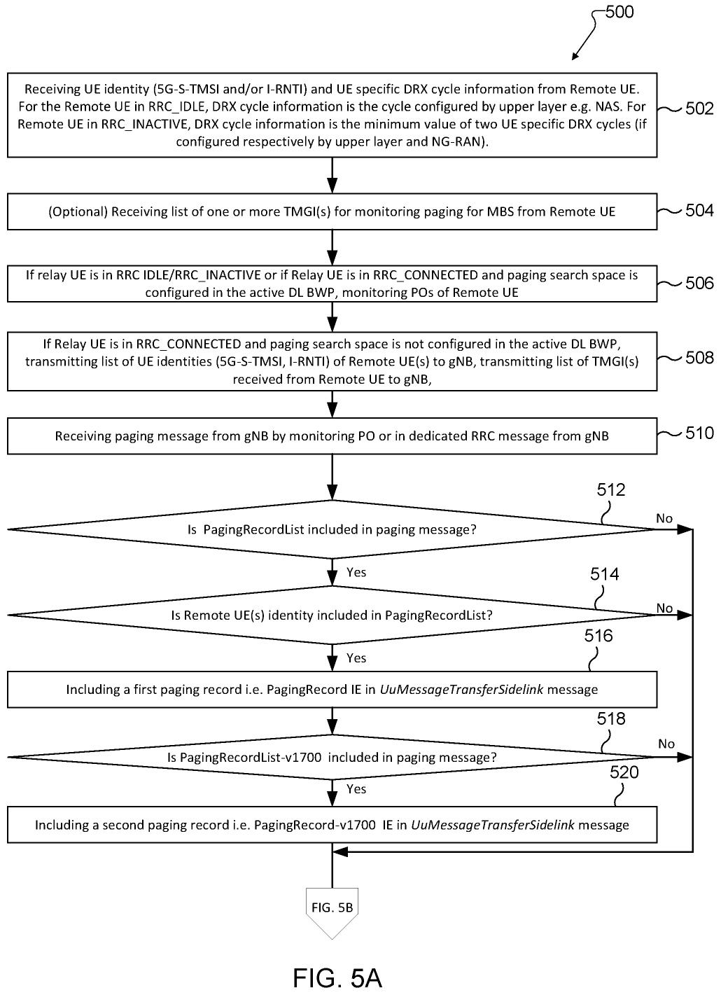

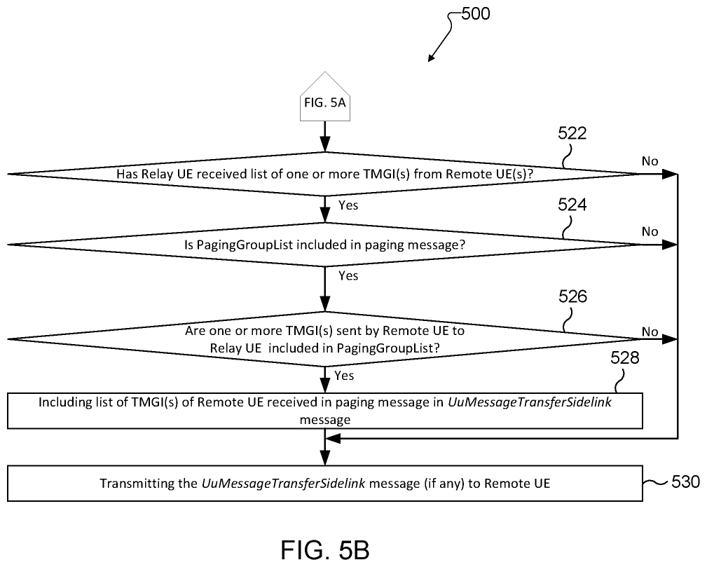

However, PagingRecord includes only UE identity and access type. As a result, the Remote UE upon receiving the UuMessageTransferSidelink from the Relay UE is not aware of the paging cause and other information such as paging for MBS (Multicast and Broadcast services). As a result, the Remote UE may have to monitor PO itself if it supports Paging cause or if it is interested to receive paging for MBS which is an additional burden and may not be possible if the Remote UE is out of coverage. To overcome this problem, the present disclosure provides a solution where a relay UE monitors paging of a remote UE, and then transmits the paging information to the remote UE. An example is illustrated in FIG. 5.

FIGS. 5A-5B illustrate a method 500 for monitoring paging of a remote UE by a relay UE according to embodiments of the present disclosure. An embodiment of the method illustrated in FIGS. 5A-5B is for illustration only. One or more of the components illustrated in FIGS. 5A-5B may be implemented in specialized circuitry configured to perform the noted functions or one or more of the components may be implemented by one or more processors executing instructions to perform the noted functions. Other embodiments for monitoring paging of a remote UE by a relay UE could be used without departing from the scope of this disclosure.

The method 500 begins at step 502. At step 502, a remote UE such as UE 410 of FIG. 4 sends its 5G-S-TMSI to a relay UE, such as UE 406 of FIG. 4. The remote UE sends its I-RNTI if the remote UE is in an RRC_INACTIVE state. If the remote UE is in an RRC_IDLE state, the remote UE also sends its UE specific DRX cycle (if configured by upper layer e.g., NAS) to the relay UE for requesting to perform paging/PO monitoring. If the remote UE is in a RRC_INACTIVE state, the remote UE sends the minimum value of two UE specific DRX cycles (if configured respectively by upper layer and NG-RAN) to the Relay UE for paging/PO monitoring.

At step 504, which is optional, if the remote UE supports MBS and has joined one or more MBS session(s), the remote UE sends a list of one or more TMGI(s) to the relay UE for monitoring paging for MBS. The remote UE may also indicate that it supports paging cause. These parameters can be sent by the remote UE to the relay UE using a RRC signaling message over a sidelink signaling radio bearer (SL SLRB) or over a sidelink data radio bearer. The signaling message (e.g., RemoteUEInformationSidelink) carrying these parameters is transmitted in a MAC PDU wherein the Remote UE's layer 2 identity (or part of Remote UE's layer 2 identity) and Relay UE's layer 2 identity (part of Relay UE's layer 2 identity) is added in the header of the MAC PDU. The MAC PDU is then transmitted over PSSCH.

Upon receiving the message from remote UE(s) for monitoring paging/PO, the Relay UE performs steps 506-530. At step 506, if the relay UE is in a RRC IDLE or RRC INACTIVE state, the relay UE monitors paging occasions of Remote UE(s). The paging occasions are determined as described earlier herein based on information (5G-S-TMSI, UE specific DRX cycle) received from the remote UE and information received from the gNB (default DRX cycle and paging parameters such as number of paging occasions (Ns), Number of paging frames (N) and paging offset). In the monitored paging occasion(s), the relay UE receives PDCCH addressed to P-RNTI based on which the relay UE decodes the DL TB including paging message.

At step 506, if the relay UE is in an RRC CONNECTED state and if paging search space is configured in the active DL BWP, the relay UE monitors paging occasions of the remote UE(s). The paging occasions are determined as described earlier herein based on information (5G-S-TMSI, UE specific DRX cycle) received from remote UE and information received from the gNB (default DRX cycle and paging parameters such as number of paging occasions (Ns), Number of paging frames (N) and paging offset). In the monitored paging occasion(s), Relay UE receives PDCCH addressed to P-RNTI based on which it decodes the DL TB including paging message.

At step 508, if the relay UE is in an RRC CONNECTED state and if paging search space is not configured in the active DL BWP, the relay UE sends list of UE identities (5G-S-TMSI, I-RNTI) received from remote UE(s) to the gNB in a dedicated RRC message (e.g., SidelinkUEInformationNR). If there is paging for one or more UE identities received from the relay UE, at step 510 the gNB sends a paging message including information about the paged UEs to the relay UE in a dedicated RRC message (e.g., RRCReconfiguration message). The paging message includes a first paging record list e.g. PagingRecordList (a list of PagingRecord, paging record includes UE identity and optionally access type indicating non3GPP) and optionally a second paging record list e.g. PagingRecordList-v1700 (a list of PagingRecord-v1700, PagingRecord-v1700 comprises pagingCause). At step 508 the relay UE may also send a list of TMGI(s) received from the remote UE(s) to the gNB in a RRC message (e.g., SidelinkUEInformationNR). If there is paging for one or more UE identities received from the relay UE, at step 510 the gNB sends a paging message including information about the paged TMGI(s) to the relay UE in a dedicated RRC message (e.g., RRCReconfiguration message), and a list of TMGI(s) is included in paging message.

At step 512, if the received paging message includes PagingRecordList, the method proceeds to step 514. Otherwise, the method proceeds to step 522.

At step 514, if an entry (say kth, k is an integer) in PagingRecordList includes a UE identity (5G-S-TMSI or I-RNTI) of the remote UE which the relay UE has received from Remote UE, the method proceeds to step 516. Otherwise, the method proceeds to step 522.

At step 516, the relay UE includes a first paging record i.e., PagingRecord IE in a UuMessageTransferSidelink message. The PagingRecord is the one which is included in PagingRecordList and includes the remote UE's identity. The first paging record comprises the UE identity and optionally access type indicating non3GPP.

At step 518, if the received paging message includes PagingRecordList-v1700 (or if the received paging message includes PagingRecordList-v1700 and the remote UE has indicated to the relay UE that it supports paging cause), the method proceeds to step 520. Otherwise, the method proceeds to step 522.

At step 520, the relay UE includes a second paging record i.e., PagingRecord-v1700 IE in the UuMessageTransferSidelink message. The PagingRecord-v1700 is the one which is included in kth entry in PagingRecordList-v1700 where k is the entry number in PagingRecordList which includes the remote UE's UE identity.

At step 522, if the remote UE has sent list of one or more TMGI(s) to the relay UE, the method proceeds to step 524. Otherwise, the method proceeds to step 530.

At step 524, if the received paging message includes PagingGroupList, the method proceeds to step 526. Otherwise, the method proceeds to step 530.

At step 526, if the PagingGroupList includes one or more TMGI(s) sent by the remote UE to the relay UE, the method proceeds to step 528. Otherwise, the method proceeds to step 530.

At step 528, the relay UE includes a list of TMGI(s) of the remote UE received in the paging message in the UuMessageTransferSidelink message.

At step 520, the relay UE transmits/sends the UuMessageTransferSidelink to remote UE.

Although FIGS. 5A-5B illustrate one example of a method 500 for monitoring paging of a remote UE by a relay UE, various changes may be made to FIGS. 5A-5B. For example, while shown as a series of steps, various steps in FIGS. 5A-5B could overlap, occur in parallel, occur in a different order, occur any number of times, be omitted, or replaced by other steps.

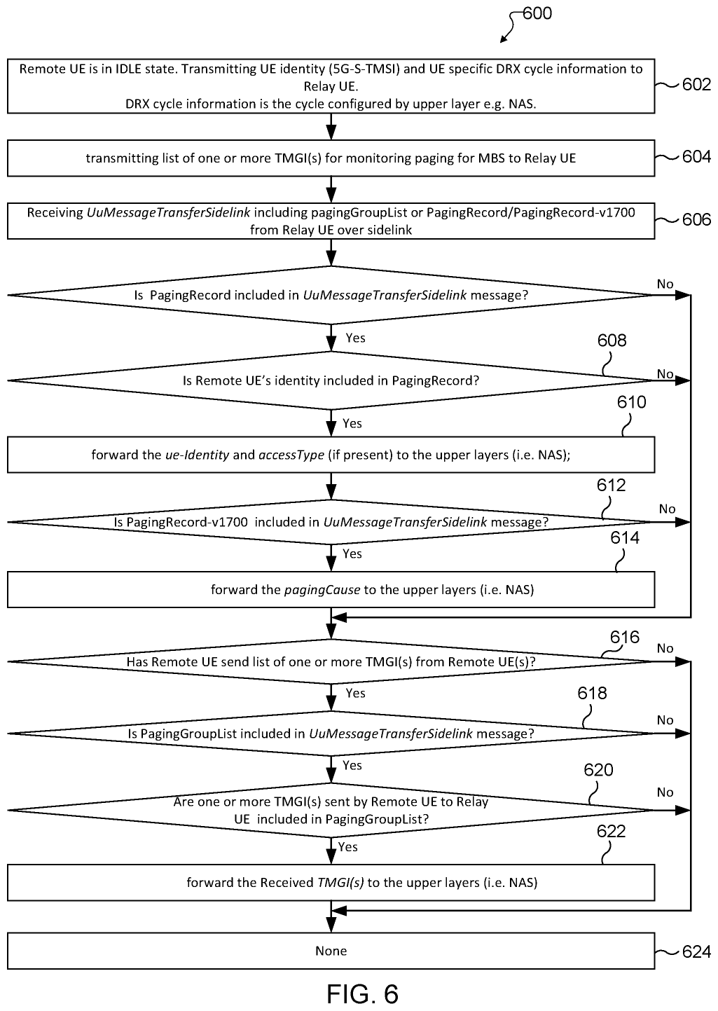

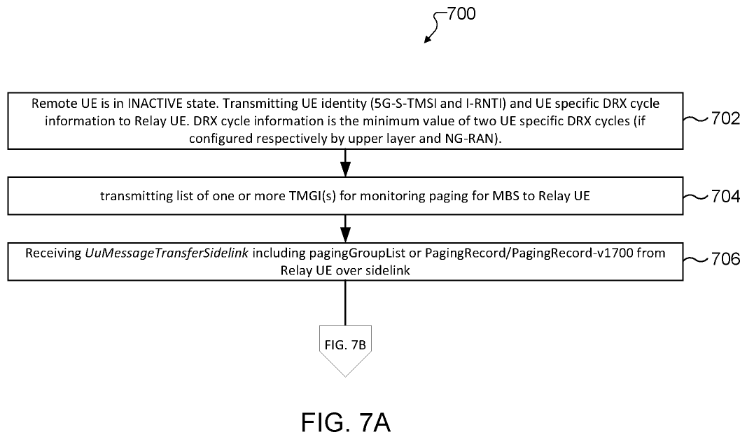

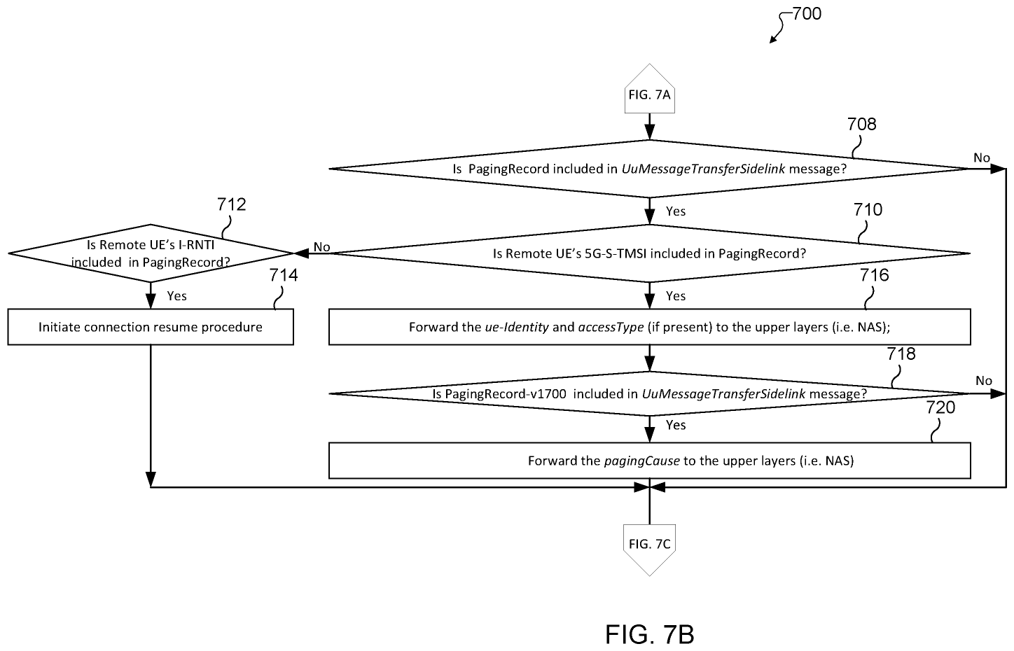

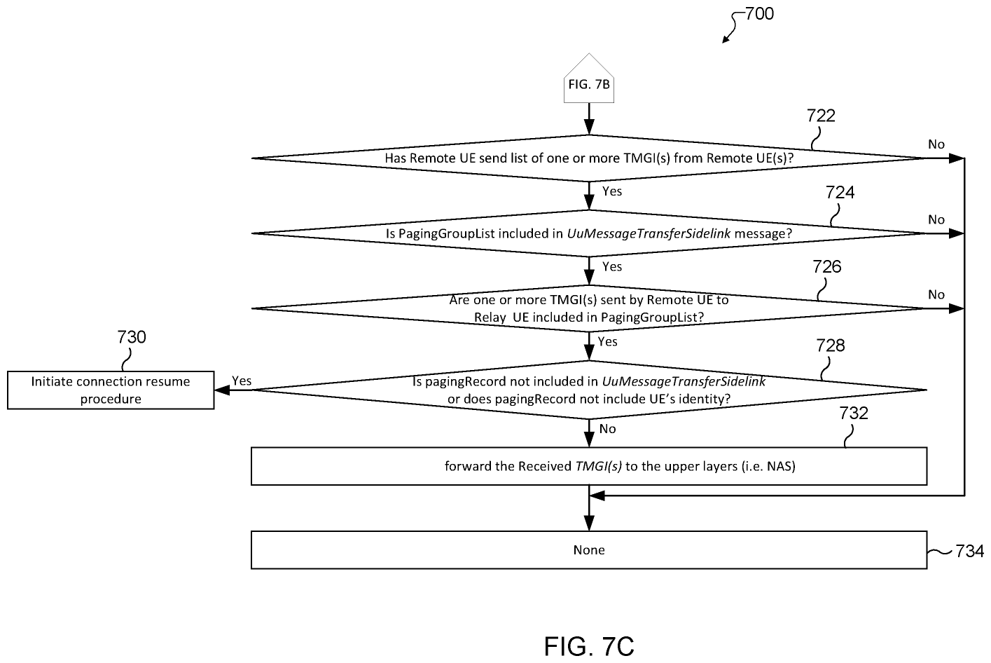

Upon receiving the UuMessageTransferSidelink message from the relay UE, the remote UE may perform a first operation if the remote UE is in an RRC idle state, or the relay UE may perform a second operation if the relay UE is in an RRC inactive state. An example operation performed by the relay UE upon receiving the UuMessageTransferSidelink message while in an RRC idle state is shown in FIG. 6. An example operation performed by the relay UE upon receiving the UuMessageTransferSidelink message while in an RRC inactive state is shown in FIGS. 7A-7C.

FIG. 6 illustrates a method 600 for a remote UE responding to a UuMessageTransferSidelink message while in an RRC idle state according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for a remote UE responding to a UuMessageTransferSidelink message while in an RRC idle state could be used without departing from the scope of this disclosure.

The method 600 begins at step 602. At step 602, a remote UE such as UE 410 of FIG. 4 sends its 5G-S-TMSI to a relay UE, such as UE 406 of FIG. 4. The remote UE also sends its UE specific DRX cycle to the relay UE for requesting to perform PO monitoring.

At step 604, if the remote UE supports MBS and has joined one or more MBS session(s), the remote UE sends a list of one or more TMGI(s) to the relay UE for monitoring paging for MBS. The remote UE may also indicate that it supports paging cause. These parameters can be sent by the remote UE to the relay UE using a RRC signaling message over a sidelink signaling radio bearer (SL SLRB) or over a sidelink data radio bearer. The signaling message (e.g., RemoteUEInformationSidelink) carrying these parameters is transmitted in a MAC PDU wherein the Remote UE's layer 2 identity (or part of Remote UE's layer 2 identity) and Relay UE's layer 2 identity (part of Relay UE's layer 2 identity) is added in the header of the MAC PDU. The MAC PDU is then transmitted over PSSCH.

At step 606, the remote UE receives a UuMessageTransferSidelink message from the Relay UE including pagingGroupList or PagingRecord/PagingRecord-v1700.

At step 608, if the UuMessageTransferSidelink message includes a paging record, the method proceeds to step 610. Otherwise, the method proceeds to step 618.

At step 610, if the UuMessageTransferSidelink message includes the remote UE's identity in the paging record, the method proceeds to step 612. Otherwise, the method proceeds to step 618.

At step 612 the remote UE forwards the ue-Identity and accessType (if present) to the upper layers (i.e., NAS).

At step 614, if upper layers indicate the support of paging cause and paging cause is included in UuMessageTransferSidelink, the method proceeds to step 616. Otherwise, the method proceeds to step 618.

At step 616, the remote UE forwards the paging cause to the upper layers (i.e., NAS).

At step 618, if the remote UE has sent a list of one or more TMGI(S) from remote UE(s), the method proceeds to step 620. Otherwise, the method proceeds to step 626.

At step 620, if the UuMessageTransferSidelink message includes a paging group list, the method proceeds to step 622. Otherwise, the method proceeds to step 626.

At step 622, if one or more TMGI(s) sent by the remote UE to the relay UE are included in the paging group list, the method proceeds to step 624. Otherwise, the method proceeds to step 626.

At step 624, the remote UE forwards the received TMGI(s) to the upper layers (i.e., NAS).

At step 626, the remote UE takes no action.

Although FIG. 6 illustrates one example of a method 600 for a remote UE responding to a UuMessageTransferSidelink message while in an RRC idle state, various changes may be made to FIG. 6. For example, while shown as a series of steps, various steps in FIG. 6 could overlap, occur in parallel, occur in a different order, occur any number of times, be omitted, or replaced by other steps.

FIGS. 7A-7C illustrate a method 700 for a remote UE responding to a UuMessageTransferSidelink message while in an RRC inactive state according to embodiments of the present disclosure. An embodiment of the method illustrated in FIGS. 7A-7C is for illustration only. One or more of the components illustrated in FIGS. 7A-7C may be implemented in specialized circuitry configured to perform the noted functions or one or more of the components may be implemented by one or more processors executing instructions to perform the noted functions. Other embodiments for a remote UE responding to a UuMessageTransferSidelink message while in an RRC inactive state could be used without departing from the scope of this disclosure.

The method 700 begins at step 702. At step 702, a remote UE such as UE 410 of FIG. 4 sends its 5G-S-TMSI and I-RNTI to a relay UE, such as UE 406 of FIG. 4. The remote UE also sends the minimum value of two UE specific DRX cycles to the Relay UE for PO monitoring.

At step 704, the remote UE sends a list of one or more TMGI(s) to the relay UE for monitoring paging for MBS. The remote UE may also indicate that it supports paging cause. These parameters can be sent by the remote UE to the relay UE using a RRC signaling message over a sidelink signaling radio bearer (SL SLRB) or over a sidelink data radio bearer. The signaling message (e.g., RemoteUEInformationSidelink) carrying these parameters is transmitted in a MAC PDU wherein the Remote UE's layer 2 identity (or part of Remote UE's layer 2 identity) and Relay UE's layer 2 identity (part of Relay UE's layer 2 identity) is added in the header of the MAC PDU. The MAC PDU is then transmitted over PSSCH.

At step 706, the remote UE receives a UuMessageTransferSidelink message from the relay UE.

At step 708, if the UuMessageTransferSidelink message includes a paging record, the method proceeds to step 710. Otherwise, the method proceeds to step 722.

At step 710, if the UuMessageTransferSidelink message includes the remote UE's 5G-S-TMSI in the paging record, the method proceeds to step 716. Otherwise, the method proceeds to step 712.

At step 712, if the remote UE's I-RNTI is included in the paging record, the method proceeds to step 714.

At step 714, the remote UE initiates a connection resume procedures. if the UE is configured by upper layers with Access Identity 1, the remote UE initiates the RRC connection resumption procedure with resumeCause set to mps-PriorityAccess. If the remote UE is configured by upper layers with Access Identity 2, the remote UE initiates the RRC connection resumption procedure with resumeCause set to mcs-PriorityAccess. If the remote UE is configured by upper layers with one or more Access Identities equal to 11-15, the remote UE initiates the RRC connection resumption procedure with resumeCause set to highPriorityAccess. Otherwise, the remote UE initiates the RRC connection resumption procedure with resumeCause set to mt-Access.

At step 716, the remote UE forwards the ue-Identity and accessType (if present) to the upper layers.

At step 718, if upper layers indicate the support of paging cause and paging cause is included in UuMessageTransferSidelink, the method proceeds to step 720. Otherwise, the method proceeds to step 722.

At step 720, the remote UE forwards the pagingCause to the upper layers.

At step 722, if the remote UE has sent a list of one or more TMGI(S) from remote UE(s), the method proceeds to step 724. Otherwise, the method proceeds to step 734.

At step 724 if the UuMessageTransferSidelink message includes a paging group list, the method proceeds to step 726. Otherwise, the method proceeds to step 734.

At step 726, if one or more TMGI(s) sent by the remote UE to the relay UE are included in the paging group list, the method proceeds to step 728. Otherwise, the method proceeds to step 734.

At step 728, if none of the ue-Identity included in any of the PagingRecord, if included in the UuMessageTransferSidelink, matches the UE identity allocated by upper layers, or ifPagingRecord, is not included in the UuMessageTransferSidelink message, the method proceeds to step 730. Otherwise, the method proceeds to step 732.

At step 730, the remote UE begins a connection resume procedure. If the remote UE is configured by upper layers with Access Identity 1, resumeCause is set to mps-PriorityAcces. If the remote LIE is configured by upper layers with Access Identity 2, resumeCause is set to mcs-PriorityAccess. If the remote LIE if the LIE is configured by upper layers with one or more Access Identities equal to 11-15, resumeCause is set to highPriorityAccess. Otherwise, resumeCause is set to mt-Access.

At step 732, the remote LIE forwards the TMGI(s) to the upper layers.

At step 734, the remote LIE takes no action.

Although FIGS. 7A-7C illustrate one example of a method 700 for a remote LIE responding to a UuMessageTransferSidelink message while in an RRC inactive state, various changes may be made to FIGS. 7A-7C. For example, while shown as a series of steps, various steps in FIGS. 7A-7C could overlap, occur in parallel, occur in a different order, occur any number of times, be omitted, or replaced by other steps.

As discussed, previously herein, a relay UE may transmit a UuMessageTransferSidelink message to a remote UE. One example of encoding UuMessageTransferSidelink message is as follows:

UuMessage TransferSidelink message

-- ASN1START
-- TAG-UUMESSAGETRANSFERSIDELINK-START

| | |
|---|---|
| UuMessage TransferSidelink-r17 ::= | SEQUENCE { |
| criticalExtensions | CHOICE { |
| uuMessageTransferSidelink-r17 | UuMessageTransferSidelink-r17-IEs, |
| criticalExtensionsFuture | SEQUENCE { } |

}
}

| | |
|---|---|
| UuMessageTransferSidelink-r17-IEs ::= | SEQUENCE { |
| sl-PagingDelivery-r17 | OCTET STRING (CONTAINING PagingRecord) OPTIONAL, -- |

Need N

| | | |
|---|---|---|
| sl-SIB1-Delivery-r17 | OCTET STRING (CONTAINING SIB1) | OPTIONAL, -- |

Need N
sl-SystemInformationDelivery-r17 OCTET STRING (CONTAINING
SystemInformation)OPTIONAL,-- Need N

| | | |
|---|---|---|
| lateNonCriticalExtension | OCTET STRING | OPTIONAL, |

| | |
|---|---|
| nonCriticalExtension | UuMessageTransferSidelink-v17xx-IEs OPTIONAL |

}

| | |
|---|---|
| UuMessageTransferSidelink-v17xx-IEs::= | SEQUENCE { |
| sl-PagingDelivery-v17xx | OCTET STRING (CONTAINING PagingRecord-v1700) |

OPTIONAL, -- Need N

| | | |
|---|---|---|
| pagingGroupList-r17 | PagingGroupList-r17 | OPTIONAL, -- Need N |
| nonCriticalExtension | SEQUENCE { } | OPTIONAL |

}
-- TAG-UUMESSAGETRANSFERSIDELINK-STOP
-- ASN1STOP

Another example of encoding UuMessageTransferSidelink message is as follows:

| | |
|---|---|
| UuMessageTransferSidelink-r17-IEs ::= | SEQUENCE { |
| sl-PagingDelivery-r17 | OCTET STRING (CONTAINING PagingRecord) OPTIONAL, -- |

Need N

| | | |
|---|---|---|
| sl-SIB1-Delivery-r17 | OCTET STRING (CONTAINING SIB1) | OPTIONAL, -- Need |

N
sl-SystemInformationDelivery-r17 OCTET STRING (CONTAINING
SystemInformation)OPTIONAL,-- Need N

| | | |
|---|---|---|
| lateNonCriticalExtension | OCTET STRING | OPTIONAL, |

| | |
|---|---|
| nonCriticalExtension | UuMessageTransferSidelink-v17xx-IEs OPTIONAL |

}

| | |
|---|---|
| UuMessageTransferSidelink-v17xx-IEs::= | SEQUENCE { |

sl-PagingDelivery-v17xx OCTET STRING (CONTAINING sl-
PagingRecord) OPTIONAL, -- Need N

| | | |
|---|---|---|
| pagingGroupList-r17 | PagingGroupList-r17 | OPTIONAL, -- Need N |
| nonCriticalExtension | SEQUENCE { } | OPTIONAL |

}

| sl-PagingRecord ::= | SEQUENCE { | |
|---|---|---|
| ue-Identity | PagingUE-Identity, | |
| accessType | ENUMERATED {non3GPP} | OPTIONAL, -- Need N |
| pagingCause-r17 | ENUMERATED {voice} | OPTIONAL -- Need N |

}

If the relay UE receives a paging cause for the remote UE in the paging message received from the gNB, it includes sl-PagingDelivery-v17xx in UuMessageTransferSidelink instead of sl-PagingDelivery-r17.

Another example of encoding UuMessageTransferSidelink message is as follows:

| | |
|---|---|
| UuMessageTransferSidelink-r17-IEs ::= | SEQUENCE { |

OCTET STRING (CONTAINING PagingRecord) OPTIONAL, -- Need N

| | | |
|---|---|---|
| sl-SIB1-Delivery-r17 | OCTET STRING (CONTAINING SIB1) | OPTIONAL, -- Need |

N
sl-SystemInformationDelivery-r17 OCTET STRING (CONTAINING
SystemInformation)OPTIONAL,-- Need N

| | | |
|---|---|---|
| lateNonCriticalExtension | OCTET STRING | OPTIONAL, |

| | |
|---|---|
| nonCriticalExtension | UuMessageTransferSidelink-v17xx-IEs OPTIONAL |

}

| | |
|---|---|
| UuMessageTransferSidelink-v17xx-IEs::= | SEQUENCE { |

sl-PagingDelivery-v17xx OCTET STRING (CONTAINING sl-
PagingRecord) OPTIONAL, -- Need N

| | | |
|---|---|---|
| pagingGroupList-r17 | PagingGroupList-r17 | OPTIONAL, -- Need N |
| nonCriticalExtension | SEQUENCE { } | OPTIONAL |

}

| sl-PagingRecord ::= | SEQUENCE { | |
|---|---|---|
| ue-Identity | PagingUE-Identity, | |
| accessType | ENUMERATED {non3GPP} | OPTIONAL, -- Need N |
| pagingCause-r17 | ENUMERATED {voice} | OPTIONAL -- Need N |

}

If the relay UE receives a ue-identity of the remote UE in a paging message received from the gNB, it includes sl-PagingDelivery-v17xx in UuMessageTransferSidelink.

Another example of encoding UuMessageTransferSidelink message is as follows:

| | |
|---|---|
| UuMessageTransferSidelink-r17-IEs ::= | SEQUENCE { |

OCTET STRING (CONTAINING PagingRecord) OPTIONAL, -- Need N

| | | |
|---|---|---|
| sl-SIB1-Delivery-r17 | OCTET STRING (CONTAINING SIB1) | OPTIONAL, -- Need |

N
sl-SystemInformationDelivery-r17 OCTET STRING (CONTAINING
SystemInformation)OPTIONAL,-- Need N

| | | |
|---|---|---|
| lateNonCriticalExtension | OCTET STRING | OPTIONAL, |

| | |
|---|---|
| nonCriticalExtension | UuMessageTransferSidelink-v17xx-IEs OPTIONAL |

}

| | |
|---|---|
| UuMessageTransferSidelink-v17xx-IEs::= | SEQUENCE { |
| sl-PagingDelivery-v17xx | OCTET STRING (CONTAINING |

PagingMessage) OPTIONAL, -- Need N

| | | |
|---|---|---|
| pagingGroupList-r17 | PagingGroupList-r17 | OPTIONAL, -- Need N |
| nonCriticalExtension | SEQUENCE { } | OPTIONAL |

}

If the relay UE receives a paging message including ue-identity of the remote UE from the gNB, it generates a new PagingMessage including only the remote UE's info and includes this PagingMessage in UuMessageTransferSidelink.

In one embodiment, the gNB sends a RRCReconfiguration message to a UE including logical channel configuration for one or more logical channels. A logical channel can be an uplink logical channel or a downlink logical channel or both.

In one embodiment, for a logical channel with uplink, the gNB includes a first configuration of bitRateQueryProhibitTimer for the uplink direction in the corresponding logical channel configuration. The logical channel configuration is encoded in a LogicalChannelConfig IE. For the first configuration of bit rate query prohibit timer, a parameter bitRateQueryProhibitTimer is included in a ul-SpecificParameters IE, wherein the ul-SpecificParameters IE is included in the LogicalChannelConfig IE.

In one embodiment, the timer given by bitRateQueryProhibitTimer is applied by the UE for the logical channel's uplink direction. That is, a timer for a value given by bitRateQueryProhibitTimer is started for the logical channel's uplink direction when UE transmits recommended bit rate query of the logical channel's uplink direction.

In one embodiment, if this logical channel also has downlink, the first configuration of the bit rate query prohibit timer (parameter bitRateQueryProhibitTimer) is also applied for the downlink direction of this logical channel. The timer given by bitRateQueryProhibitTimer is applied by the UE for the logical channel's downlink direction. That is, the timer for a value given by bitRateQueryProhibitTimer is started for the logical channel's downlink direction when the UE transmits recommended bit rate query of the logical channel's downlink direction.

In one embodiment, for a logical channel with downlink only, the gNB includes a second configuration of bit rate query prohibit timer bitRateQueryProhibitTimer for the downlink direction in the corresponding logical channel configuration. For the second configuration of the bit rate query prohibit timer, a parameter bitRateQueryProhibitTimer-v15xx is included in LogicalChannelConfig IE. The timer given by the bitRateQueryProhibitTimer-v15xx is applied by the UE for this logical channel. That is, the timer for a value given by bitRateQueryProhibitTimer-v15xx is started for the logical channel's downlink direction when UE transmits recommended bit rate query of the logical channel's downlink direction.

The IE LogicalChannelConfig is used to configure the logical channel parameters. An example of encoding the LogicalChannelConfig information element is as follows:

LogicalChannelConfig information element

-- ASN1START
-- TAG-LOGICALCHANNELCONFIG-START

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, kBps64, |

kBps128, kBps256, kBps512,
kBps1024, kBps2048, kBps4096, kBps8192, kBps16384,
kBps32768, kBps65536, infinity},

| | |
|---|---|
| bucketSizeDuration | ENUMERATED {ms5, ms10, ms20, ms50, ms100, ms150, |

ms300, ms500, ms1000,

| | |
|---|---|
| | spare7, spare6, spare5, spare4, spare3,spare2, spare1}, |
| allowedServingCells | SEQUENCE (SIZE (1..maxNrofServingCells-1)) OF |

ServCellIndex

OPTIONAL, -- PDCP-

CADuplication

| | |
|---|---|
| allowedSCS-List | SEQUENCE (SIZE (1..maxSCSs)) OF SubcarrierSpacing |

OPTIONAL, -- Need R

| | |
|---|---|
| maxPUSCH-Duration | ENUMERATED {ms0p02, ms0p04, ms0p0625, |

ms0p125, ms0p25, ms0p5, spare2, spare1}

| | |
|---|---|
| | OPTIONAL, -- Need R |
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | SchedulingRequestId OPTIONAL, - |

- Need R

| | |
|---|---|
| logicalChannelSR-Mask | BOOLEAN, |

```
      logicalChannelSR-DelayTimerApplied BOOLEAN,
      ...,
```

| | |
|---|---|
| bitRateQueryProhibitTimer | ENUMERATED { s0, s0dot4, s0dot8, s1dot6, s3, s6, |

s12,s30} OPTIONAL -- Need R

| | |
|---|---|
| } | OPTIONAL, -- Cond UL |

```
  ...,
  [[
```

| | |
|---|---|
| bitRateQueryProhibitTimer-DL | ENUMERATED { s0, s0dot4, s0dot8, s1dot6, s3, s6, |

s12,s30} OPTIONAL -- Cond DL
]]
}
-- TAG-LOGICALCHANNELCONFIG-STOP
-- ASN1STOP

In one embodiment, a bitRateQueryProhibitTimer is used. bitRateQueryProhibitTimer is a timer is used for bit rate recommendation query in TS 38.321 [3], in seconds. Value s0 means 0 s, s0dot4 means 0.4 s and so on. If bitRateQueryProhibitTimer is signaled, UE applies it for UL direction of this logical channel.

In one embodiment, a bitRateQueryProhibitTimerDL is used. The bitRateQueryProhibitTimerDL is a timer used for bit rate recommendation query in TS 38.321 [3], in seconds. Value s0 means 0 s, s0dot4 means 0.4 s and so on. If bitRateQueryProhibitTimerDL is signaled, the UE applies it for the DL direction of this logical channel.

TABLE 1

| | |
|---|---|
| DL | The field is optionally present, Need R, for a logical channel |
| | with downlink. Otherwise, it is absent. |

According to current procedure in the RRC specification, upon reception of paging message, if the UE is in a RRC_INACTIVE state and the UE has joined one or more MBS session(s) indicated by the TMGI(s) included in the pagingGroupList, if none of the ue-Identity included in any of the PagingRecord, if included in the Paging message, matches the UE identity allocated by upper layers, the UE initiates the RRC connection resumption procedure.

This excerpt only considers the scenario when paging record(s) are included in the paging message. The scenario where there are no paging records (i.e. there is no PagingRecordList) in the paging message is not addressed. If a UE is in an RRC_INACTIVE state and the UE has joined one or more MBS session(s) indicated by the TMGI(s) included in the pagingGroupList and if there aren't any paging records in the paging message, the UE will not initiate a connection resume procedure. As a result, the UE will not be able to receive IBS sessions for which the paging is received. As a solution to this issue, the present disclosure provides the following procedure.

Upon receiving the Paging message by the UE from the gNB, if the UE is in an RRC_INACTIVE state and the UE has joined one or more MBS session(s) indicated by the TMGI(s) included in the pagingGroupList, if any, included in the Paging message, if none of the ue-Identity included in any of the PagingRecord, if included in the Paging message, matches the UE identity allocated by upper layers; or if PagingRecord is not included in the Paging message (i.e., there is no PagingRecord or PagingRecordList in the Paging message), the UE initiates the RRC connection resumption procedure with resumeCause set as below:
If the UE is configured by upper layers with Access Identity 1, the UE sets resumeCause to mps-PriorityAccess.
Otherwise, if the UE is configured by upper layers with Access Identity 2, the UE sets resumeCause to mcs-PriorityAccess.
Otherwise, if the UE is configured by upper layers with one or more Access Identities equal to 11-15, the UE sets resumeCause to highPriorityAccess.
Otherwise, the UE sets resumeCause to mt-Access.

Otherwise, upon receiving the Paging message by the UE from the gNB, if the UE is in the RRC_INACTIVE state and the UE has joined one or more MBS session(s) indicated by the TMGI(s) included in the pagingGroupList, if any, included in the Paging message, the UE forwards the TMGI(s) to the upper layers.

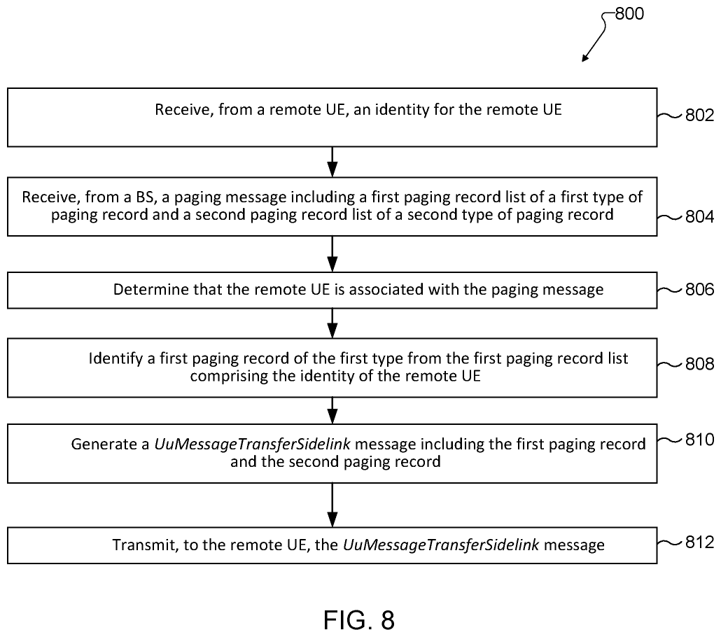

FIG. 8 illustrates a method 800 for monitoring paging of a remote UE by a relay UE according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for monitoring paging of a remote UE by a relay UE could be used without departing from the scope of this disclosure.

The method 800 begins at step 802. At step 802, a relay UE such as UE 406 of FIG. 4 receives from a remote UE such as UE 410 of FIG. 4, an identity for the remote UE. At step 804, the relay UE receives, from a BS, a paging message including a first paging record list of a first type of paging record and a second paging record list of a second type of paging record. At step 806, the relay UE determines that the remote UE is associated with the paging message. At step 808, the relay UE identifies a first paging record of the first type from the first paging record list comprising the identity of the remote UE. At step 810, the relay UE generates a UuMessageTransferSidelink message including the first paging record and the second paging record. Finally, at step 812, the relay UE transmits, to the remote UE, the UuMessageTransferSidelink message.

Although FIG. 8 illustrate one example of a method 800 for monitoring paging of a remote UE by a relay UE, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A relay user equipment (UE) comprising:
a transceiver configured to:
receive, from a remote UE, an identity for the remote UE, and
receive, from a base station (BS), a paging message including a first paging record list of a first type of paging record and a second paging record list of a second type of paging record; and
a processor, operably coupled to the transceiver, the processor configured to:
determine that the remote UE is associated with the paging message,
identify a first paging record of the first type from the first paging record list comprising the identity of the remote UE;
identify a second paging record of the second type from the second paging record list comprising a paging cause; and
generate a UuMessageTransferSidelink message including the first paging record and the second paging record;
wherein the transceiver is further configured to transmit, to the remote UE, the UuMessageTransferSidelink message.

2. The relay UE of claim 1, wherein:
the first paging record is a kth paging record in the first paging record list, where k is an integer, and
the second paging record is a kth paging record in the second paging record list.

3. The relay UE of claim 1, wherein the first type of paging record comprises an access type.

4. The relay UE of claim 1, wherein:
the transceiver is further configured to receive, from the remote UE, an indication that the remote UE supports PagingCause; and
the processor is further configured to include the second type of paging record in the UuMessageTransferSidelink message based on the indication that the remote UE supports PagingCause.

5. The relay UE of claim 1, wherein the transceiver is further configured to:
receive, from the remote UE, a first list of temporary mobile group identities (TMGIs) for monitoring paging for multicast and broadcast services (MBS); and
transmit, to the BS, the first list of TMGIs.

6. The relay UE of claim 5, wherein:
the paging message includes a second list of TMGIs including at least one TMGI from the first list of TMGIs; and
the UuMessageTransferSidelink message includes a third list of TMGIs including the TMGIs from the second list that correspond to the TMGIs from the first list.

7. The relay UE of claim 1, wherein:
the UE is in a radio resource control (RRC) inactive state; and
the processor is further configured to initiate an RRC connection resumption procedure.

8. The relay UE of claim 7, wherein:
the transceiver is further configured to receive a second paging message including a paging group list,
the paging group list includes one or more TMGIs corresponding to one or more MBS sessions joined by the UE, and
when the second paging message does not include a paging record, the processor is further configured to initiate the RRC connection resumption procedure.

9. The relay UE of claim 1, wherein the identity for the remote UE is one of:
a 5G-S-Temporary Mobile Subscriber identity (5G-S-TMSI); and
an Inactive-Radio Network Temporary Identifier (I-RNTI).

10. Abase station (BS) comprising:
a processor; and
a transceiver operably coupled to the processor, the transceiver configured to:
receive, from a remote user equipment (UE), a first list of temporary mobile group identities (TMGIs) for monitoring paging for multicast and broadcast services (MBS); and
transmit, to the UE, a paging message including a first paging record list of a first type of paging record, a second paging record list of a second type of paging record, and a second list of TMGIs including at least one TMGI from the first list of TMGIs.

11. The BS of claim 10, wherein:
the transceiver is further configured to transmit a second paging message including a paging group list; and
the paging group list includes one or more TMGIs corresponding to one or more MBS sessions joined by the UE.

12. A method of operating a relay user equipment (UE) comprising:
receiving, from a remote UE, an identity for the remote UE;
receiving, from a base station (BS), a paging message including a first paging record list of a first type of paging record and a second paging record list of a second type of paging record;
determining that the remote UE is associated with the paging message;
identifying a first paging record of the first type from the first paging record list comprising the identity of the remote UE;
identifying a second paging record of the second type from the second paging record list comprising a paging cause;
generating a UuMessageTransferSidelink message including the first paging record and the second paging record; and
transmitting, to the remote UE, the UuMessageTransferSidelink message.

13. The method of claim 12, wherein:
the first paging record is a kth paging record in the first paging record list, where k is an integer, and
the second paging record is a kth paging record in the second paging record list.

14. The method of claim 12, wherein the first type of paging record comprises an access type.

15. The method of claim 12, further comprising:
receiving, from the remote UE, an indication that the remote UE supports PagingCause; and
including the second type of paging record in the UuMessageTransferSidelink message based on the indication that the remote UE supports PagingCause.

16. The method of claim 12, further comprising:
receiving, from the remote UE, a first list of temporary mobile group identities (TMGIs) for monitoring paging for multicast and broadcast services (MBS); and
transmitting, to the BS, the first list of TMGIs.

17. The method of claim 16, wherein:
the paging message includes a second list of TMGIs including at least one TMGI from the first list of TMGIs; and
the UuMessageTransferSidelink message includes a third list of TMGIs including the TMGIs from the second list that correspond to the TMGIs from the first list.

18. The method of claim 12, wherein:
the UE is in a radio resource control (RRC) inactive state, and
the method further comprises initiating an RRC connection resumption procedure.

19. The method of claim 18, further comprising:
receiving a second paging message including a paging group list,
wherein the paging group list includes one or more TMGIs corresponding to one or more MBS sessions joined by the UE, and
when the second paging message does not include a paging record, initiating the RRC connection resumption procedure.

20. The method of claim 12, wherein the identity for the remote UE is one of:
a 5G-S-Temporary Mobile Subscriber identity (5G-S-TMSI); and
an Inactive-Radio Network Temporary Identifier (I-RNTI).
